(19) United States
(12) Patent Application Publication
(10) Pub. No.: US 2019/0126826 A1
(43) Pub. Date: May 2, 2019

(54) OPTRONIC VIEWING DEVICE FOR A LAND VEHICLE

(71) Applicant: THALES, COURBEVOIE (FR)

(72) Inventors: Pascal JEROT, ELANCOURT CEDEX (FR); Dominique BON, ELANCOURT CEDEX (FR); Ludovic PERRUCHOT, ELANCOURT CEDEX (FR)

(21) Appl. No.: 16/305,854

(22) PCT Filed: Jun. 1, 2017
(86) PCT No.: PCT/EP2017/063283

§ 371 Date: Nov. 29, 2018

(30) Foreign Application Priority Data
Jun. 7, 2016 (FR) 1600910

(51) Int. Cl. B60R 1/00; G01C 11/06; H04N 5/232; H04N 5/265; H04N 5/262; H04N 5/247; B60R 11/04; F41H 7/02

(52) U.S. Cl. CPC B60R 1/00; G01C 11/06; H04N 5/23238; H04N 5/265; H04N 5/2628; B60R 2011/0085; H04N 5/23299; B60R 11/04; F41H 7/02; B60R 2300/101; B60R 2300/304; H04N 5/247

(57) ABSTRACT

An optronic vision apparatus with which a land vehicle is intended to be equipped, includes a panoramic image sensor, at least one orientable camera, having a better resolution in a field of view that is smaller than the field of view of the panoramic image sensor, and an image-displaying device; wherein it also comprises a data processor that is configured or programmed to: receive at least one first image from the panoramic image sensor and one second image from the orientable camera; from the first and second images, synthesize a composite image in which at least one section of the second image is embedded in a section of the first image; and transmit the composite image to the image-displaying device. An armored vehicle equipped with such an optronic vision apparatus. A method by such an optronic apparatus is provided.

The invention relates to an optronic vision apparatus for a land vehicle, in particular an armored vehicle or a tank.

It is known to equip such a vehicle with a plurality of detecting/designating cameras that operate in the visible or in the infrared, said cameras being orientable and having a field of view of a few degrees—typically variable between 3° and 9° or between 4° and 12°, and possibly able to reach as much as 20°. These cameras have a very good resolution, but use thereof is not easy because of their small field: it is difficult for the operator to locate the small region observed by such a camera in the environment through which the vehicle is moving. In this respect, the “straw effect” is spoken of, because it is as though the operator were looking through a straw.

It is possible to mitigate this drawback by modifying the optics of these cameras so as to allow them to operate in a very-large-field mode (field as large as 40°-45°). It is expensive to implement such a solution and, in addition, switching the camera to very-large-field mode prevents simultaneous small-field vision.

Document U.S. 2002/75258 describes a surveillance system comprising a panoramic first camera with a plurality of lenses, and an orientable high-resolution second camera. In this system, a high-resolution image acquired by the second camera is embedded into a panoramic image issued from the first camera.

The invention aims to overcome the drawbacks of the prior art, and to provide a vision system that is better suited to the requirements of the crew of a vehicle such as an AFV or tank.

To do this, it exploits the fact that modern armored vehicles are often equipped with a very-large-field vision system, for example a hemispherical sensor such as the “ANTARES” system from Thales, which enables vision over an azimuthal angle of 360° and along a vertical arc of −15° to 75°. This very large field of view includes that of the one or more detecting/designating cameras, at least for certain ranges of orientation of the latter. An idea on which the invention is based thus consists in combining, in a given display, an image section acquired by such a very-large-field vision system and an image acquired by a detecting/designating camera. According to the invention, the high-resolution small-field image delivered by the detecting/designating camera is embedded into a section of a lower-resolution larger-field image issued from the vision system. Thus a synthesis image corresponding to the image that would be acquired by a virtual camera having the same orientation as the detecting/designating camera, but a larger field of view, is obtained. Advantageously, the user may zoom in, in order to exploit the high-resolution of the detecting/designating camera, or zoom out, in order to increase his field of view and, for example, identify reference points.

Thus, one subject of the invention is an optronic vision apparatus with which a land vehicle is intended to be equipped, comprising:
a panoramic image sensor;
at least one orientable camera, having a better resolution in a field of view that is smaller than the field of view of the panoramic image sensor and that is contained in the latter field of view for at least one set of orientations of the camera; and
an image-displaying device;

also comprising a data processor that is configured or programmed to:
receive at least one first image from said panoramic image sensor and one second image from said orientable camera;
from the first and second images, synthesize a composite image in which at least one section of the second image is embedded in a section of the first image; and
transmit said composite image to the image-displaying device; the data processor being configured or programmed to synthesize said composite image such that it corresponds to an image that would be acquired by a virtual camera having the same orientation as said orientable camera, but a larger field of view.

According to particular embodiments of such an apparatus:

The data processor may be configured or programmed to modify the size of the field of view of said composite image in response to a command originating from a user.

The data processor may be configured or programmed to synthesize in real-time a stream of said composite images from a stream of said first images and a stream of said second images.

The image-displaying device may be a portable displaying device equipped with orientation sensors, the apparatus also comprising a system for servo-controlling the orientation of the camera to that of the portable displaying device.

The panoramic image sensor and the orientable camera may be designed to operate in different spectral ranges.

The panoramic image sensor may be a hemispherical sensor.

The orientable camera may have a possibly variable field of view comprised between 1° and 20° and preferably between 3° and 12°.

Another subject of the invention is an armored vehicle equipped with such an optronic vision apparatus.

Yet another subject of the invention is a method implemented by such an optronic apparatus, comprising the following steps:
receiving a first image from a panoramic image sensor;
receiving a second image from an orientable camera, said second image having a better resolution in a field of view that is smaller than the field of view of the first image and that is contained in the latter field of view;
from the first and second images, synthesizing a composite image in which at least one section of the second image is embedded in a section of the first image, said composite image corresponding to an image that would be acquired by a virtual camera having the same orientation as said orientable camera, but a larger field of view; and
displaying said composite image.

According to particular embodiments of such a method:

The method may also comprise the following step: modifying the size of the field of view of said composite image in response to a command originating from a user.

A stream of said composite images may be synthesized in real-time from a stream of said first images and a stream of said second images.

Said composite image may be displayed on a portable displaying device equipped with orientation sensors, the method also comprising the following steps: determining the orientation of said portable displaying device from signals generated by said sensors; and servo-controlling the orientation of the camera to that of the portable displaying device.

Other features, details and advantages of the invention will become apparent on reading the description given with reference to the appended drawings, which are given by way of example and in which:

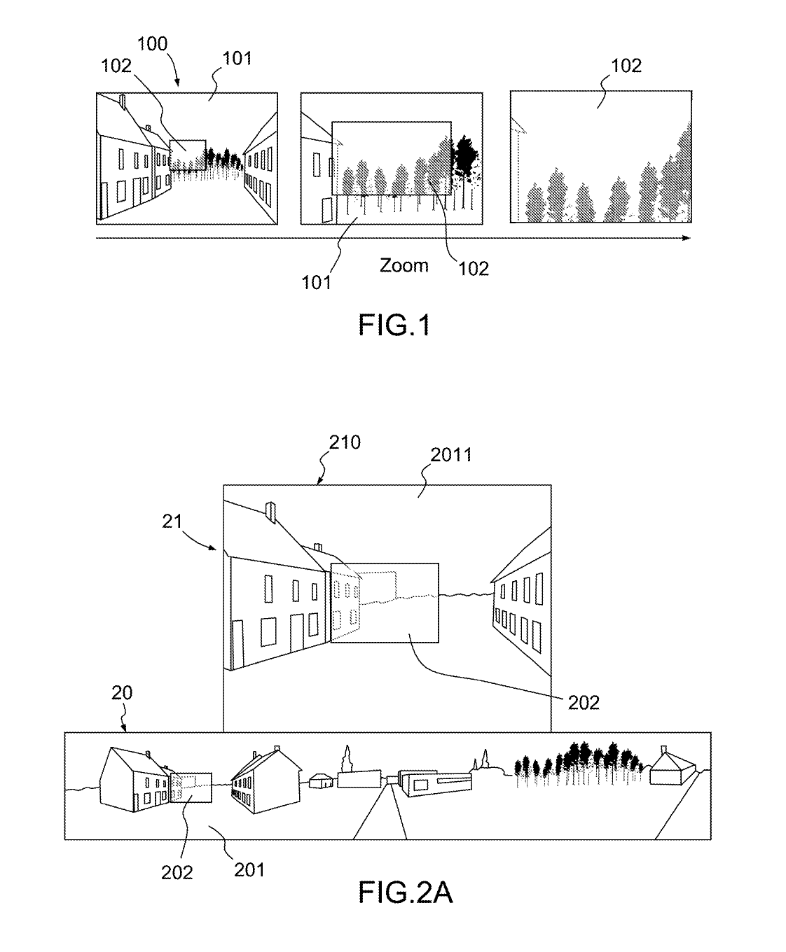

FIG. 1 is a schematic representation of the principle of the invention;

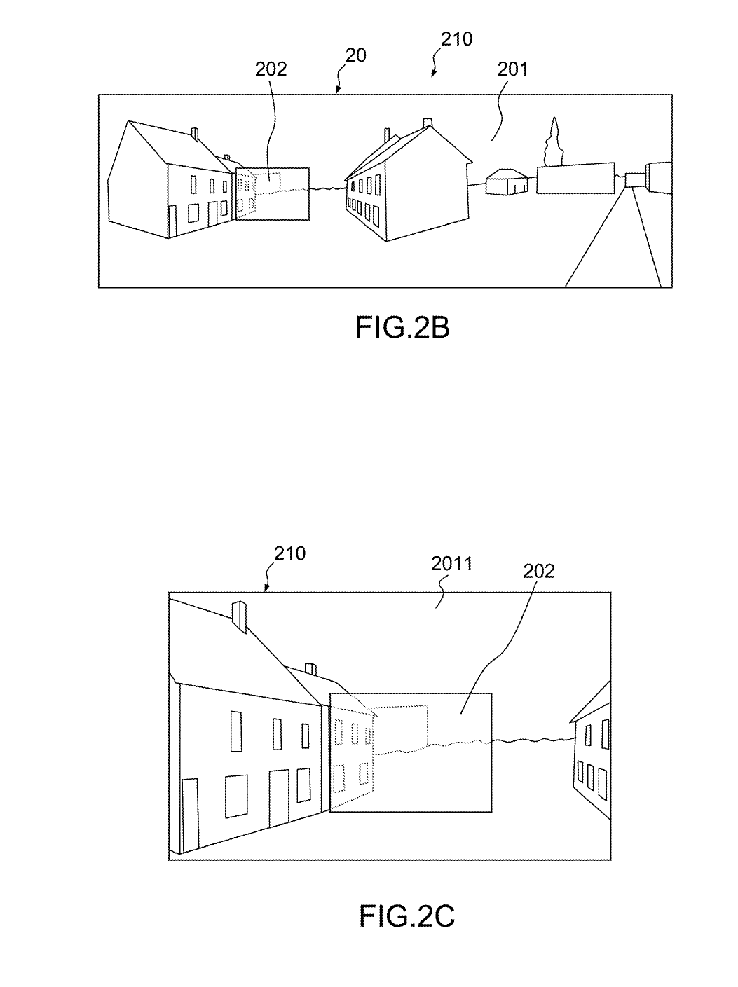

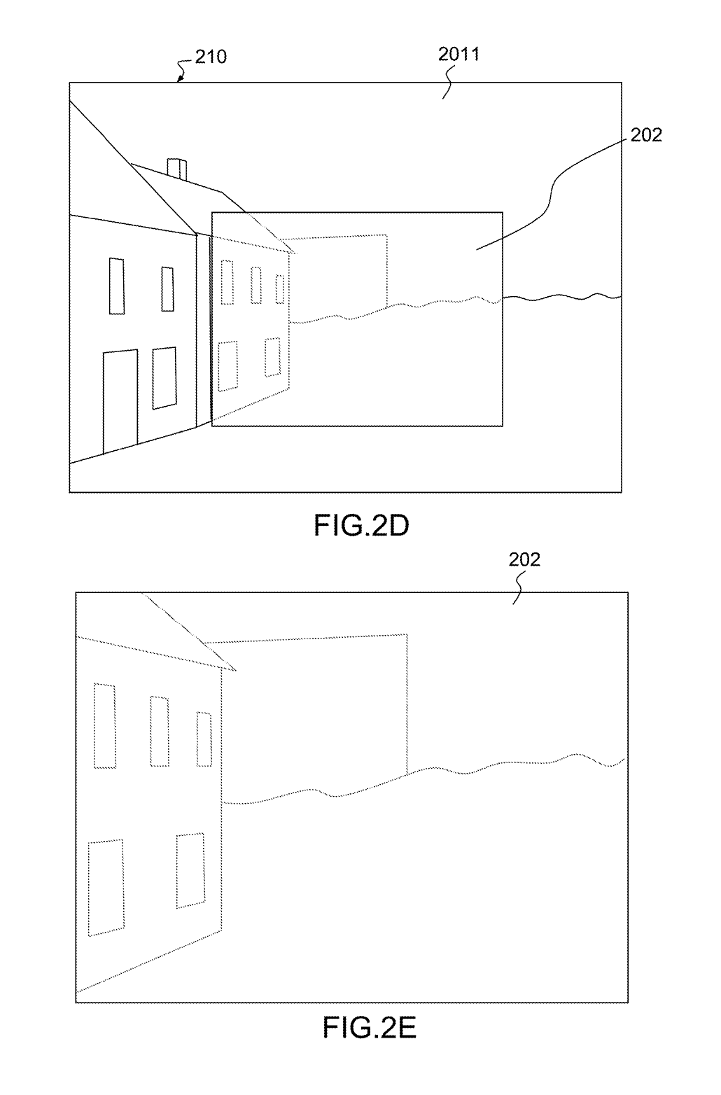

FIGS. 2A to 2E illustrate various images displayed during an implementation of the invention; and

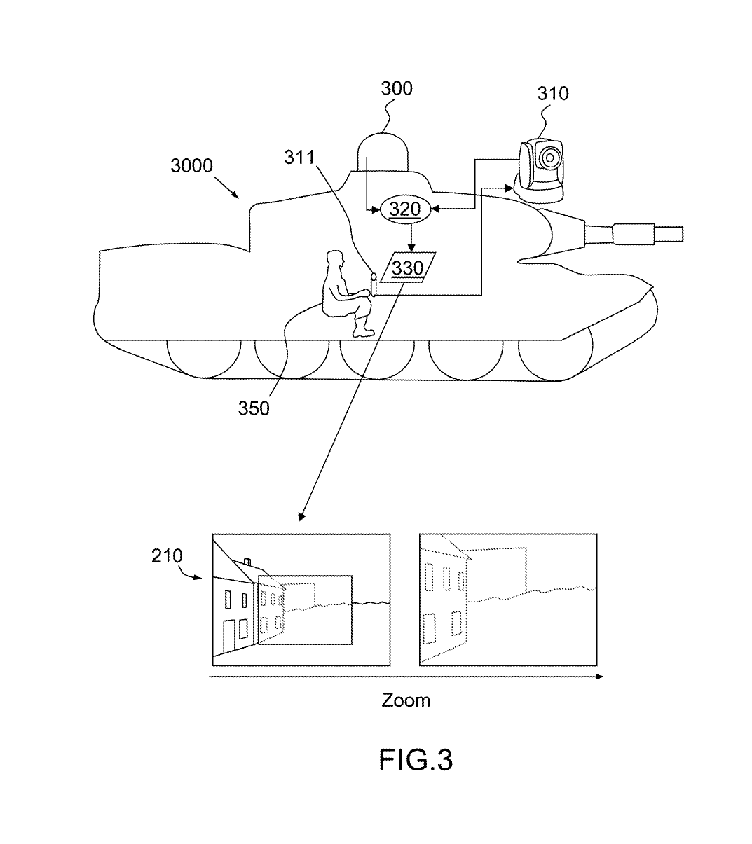

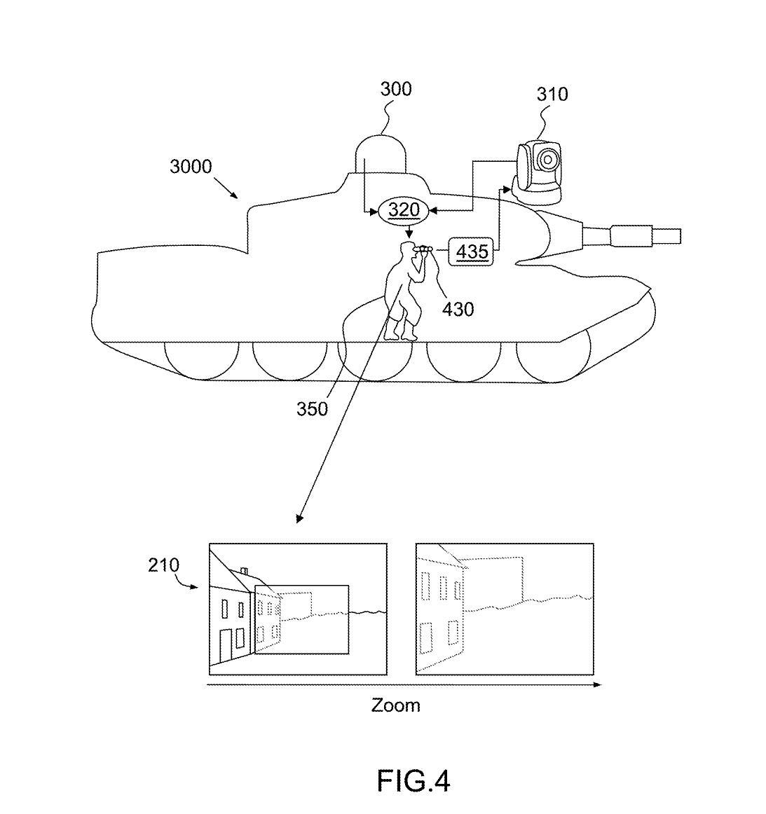

FIGS. 3 and 4 schematically illustrate two optronic apparatuses according to respective embodiments of the invention.

In this document:

The expression “detecting/designating camera” indicates an orientable digital camera with a relatively small field of view—typically smaller than or equal to 12° or even 15°, but possibly sometimes being as much as 20°, both in the azimuthal plane and along a vertical arc. A detecting/designating camera may operate in the visible spectrum, in the near infrared (night-time vision), in the mid or far infrared (thermal camera), or indeed be multispectral or even hyperspectral.

The expressions “very-large-field” and “panoramic” are considered to be equivalent and to designate a field of view extending at least 45° in the azimuthal plane, along a vertical arc or both.

The expression “hemispherical sensor” designates an image sensor having a field of view extending 360° in the azimuthal plane and at least 45° along a vertical arc. It may be a question of a single sensor, for example one using a fisheye objective, or indeed a composite sensor consisting of a set of cameras of smaller field of view and a digital processor that combines the images acquired by these cameras. A hemispherical sensor is a particular type of panoramic, or very-large-field, image sensor.

As was explained above, one aspect of the invention consists in combining, in a given display, an image section acquired by a hemispherical vision system (or more generally by a very-large-field vision system) and an image acquired by a detecting/designating camera. This leads to the synthesis of one or more composite images that are displayed by means of one or more displaying devices, such as screens, virtual reality headsets, etc.

When using an apparatus according to the invention, an operator may, for example, select a large-field viewing mode—say a field of 20° (in the azimuthal plane)×15° (along a vertical arc). The selection is performed with a suitable interface tool: a keyboard, a thumbwheel, a joystick, etc. A suitably programmed data processor then selects a section of an image, issued from the hemispherical vision system, having the desired field size and oriented in the sighting direction of the detecting/designating camera. The image acquired by the detecting/designating camera—which for example corresponds to a field of 9°×6° size, is embedded into the center of this image, with the same magnification. This is illustrated by the left-hand panel of FIG. 1, in which the reference 100 designates the composite image, 101 corresponds to the exterior portion of this composite image, which originates from the hemispherical vision system and which provides a “context” allowing the operator to get his bearings, whereas 102 designates its central portion, which originates from the detecting/designating camera. It will be noted that the elementary images 101 and 102 have the same magnification, there is therefore no break in continuity in the scene displayed by the composite image. Leaving aside the fact that the elementary images 101 and 102 do not have the same resolution and may correspond to separate spectral ranges, and that parallax is hard to avoid, the composite image corresponds to the image that would be acquired by a camera—which could be qualified a “virtual” camera—having the same orientation as the detecting/designating camera but a larger field of view.

Contrary to the case of the surveillance system of document U.S. 2002/75258, when the orientation of the detecting/designating camera is modified the elementary image 102 does not move in the interior of the elementary image 101. In contrast, the field of view of the latter is modified to keep the elementary image 102 aligned with its central portion. In this way, it is always the central portion of the composite image that has a high resolution.

If the operator zooms out, thereby further increasing the size of the field of view, the central portion 102 of the image shrinks. If he zooms in, this central portion 102 gets larger to the detriment of the exterior portion 101, this being shown in the central panel of FIG. 1, until said exterior portion disappears (right-hand panel in the figure). Reference is here being made to a digital zoom functionality, implemented by modifying the display. The detecting/designating camera may also comprise an optical zoom; when the camera is optically zoomed in however, the field size of the image issued from the camera decreases, and therefore the central portion 102 of the composite image 100 shrinks. A digital zoom applied to the composite image 100 may, where appropriate, restore the dimensional ratio between the images 101 and 102.

Advantageously, the detecting/designating camera and the hemispherical vision system deliver image streams at a rate of several frames per second. Preferably, these images are combined in real-time or almost real-time, i.e. with a latency not exceeding 1 second and preferably 0.02 seconds (the latter value corresponding to the standard duration of a frame).

FIGS. 2A to 2E illustrate in greater detail the composite images displayed on a screen 2 of an optronic apparatus according to the invention.

FIG. 2A shows an overview of this screen.

A strip 20 in the bottom portion of the screen corresponds to a first composite image obtained by combining the panoramic image 201 (360° in the azimuthal plane, from −15° to +75° perpendicular to this plane) issued from the hemispherical sensor and an image 202 issued from a detecting/designating camera, which in this case is an infrared camera. In fact, a rectangle of the panoramic image 201 is replaced by the image 202 (or, in certain cases, by a section of this image). If the detecting/designating camera is equipped with an optical zoom, the image 202 may have a variable size, but in any case it will occupy only a small portion of the panoramic image 201. FIG. 2B shows a detail of this strip. It will be noted that, in the case of a strip display, the composite image is not necessarily centered on the sighting direction of the detecting/designating camera.

The top portion 21 of the screen displays a second composite image 210 showing the image 202 issued from the detecting/designating camera embedded in a context 2011 issued from the hemispherical image sensor, in other words a section 2011 of the panoramic image 201. The user may decide to activate a digital zoom (independent of the optical zoom of the detecting/designating camera) in order to decrease the size of the field of view of the composite image 210. The embedded image 202 therefore appears enlarged, to the detriment of the section 2011 of the panoramic image. FIGS. 2C, 2D and 2E correspond to higher and higher zoom levels. FIG. 2E, in particular, corresponds to the limiting case in which only the image 202 issued from the detecting/designating camera is displayed (see the right-hand panel of FIG. 1). Of course, the user may at any moment decide to zoom out in order to once again see the context of the image.

One advantage of the invention is to make it possible to benefit both from the strip display 20 with identification of the region observed by the detecting/designating camera and the composite image 21 of intermediate field size. This would not be possible if an optical zoom of the detecting/designating camera were used in isolation.

Another portion of the screen may be used to display detailed views of the panoramic image 201. This is without direct relationship to the invention.

FIG. 3 schematically illustrates an optronic apparatus according to a first embodiment of the invention, installed on an armored vehicle 3000. The reference 300 designates the hemispherical image sensor mounted on the roof of the vehicle; 310 corresponds to the detecting/designating camera, installed in a turret; 311 to a joystick-type control device that allows an operator 350 to control the orientation of the camera 310 and its optical zoom; 320 designates the data processor that receives image streams from the sensor 300 and from the camera 310 and that synthesizes one or more composite images that are displayed on the screen 330. The bottom portion of this figure shows these composite images 210, which images were described above with reference to FIGS. 2A-2E.

FIG. 4 schematically illustrates an optronic apparatus according to a second embodiment of the invention, also installed on the armored vehicle 3000. This apparatus differs from that of FIG. 3 in that the display screen and the control device 311 have been replaced by a portable displaying device 430, for example resembling a pair of binoculars, a virtual reality headset or a tablet. This device 430 is equipped with position and orientation sensors: gyroscopes, accelerometers, optical sensors, etc. allowing its position and above all its orientation with respect to a coordinate system attached to the vehicle to be determined. A servo-control system 435—certain components of which may be shared with the data processor 320—servo-controls the orientation of the camera 310 to that of the device 430. The composite images displayed by the device are adapted in real-time to variations in orientation. Thus, the operator 350 is given the impression that he is looking through the armor of the vehicle 3000 with a pair of zoom binoculars. In addition, a screen may be present that displays, for example, a very-large-field composite image such as the strip 20 illustrated in FIG. 2A.

In the embodiments that have just been described, the optronic apparatus comprises a single very-large-field vision system (a hemispherical sensor) and a single detecting/designating camera. However, more generally, such an apparatus may comprise a plurality of very-large-field vision systems, for example operating in different spectral regions, and/or a plurality of detecting/designating cameras that are able to be oriented, optionally independently. Thus, a plurality of different composite images may be generated and displayed.

The data processor may be a generic computer or a microprocessor board specialized in image processing, or even a dedicated digital electronic circuit. To implement the invention, it executes image-processing algorithms that are known per se.

1. An optronic vision apparatus with which a land vehicle is intended to be equipped, comprising:
a panoramic image sensor;
at least one orientable camera, having a better resolution in a field of view that is smaller than the field of view of the panoramic image sensor and that is contained in the latter field of view for at least one set of orientations of the camera; and
an image-displaying device;
also comprising a data processor that is configured or programmed to:
receive at least one first image from said panoramic image sensor and one second image from said orientable camera;
from the first and second images, synthesize a composite image in which at least one section of the second image is embedded in a section of the first image; and
transmit said composite image to the image-displaying device; wherein the data processor is configured or programmed to synthesize said composite image such that it corresponds to an image that would be acquired by a virtual camera having the same orientation as said orientable camera, but a larger field of view.

2. The optronic vision apparatus as claimed in claim 1, wherein the data processor is configured or programmed to modify the size of the field of view of said composite image in response to a command originating from a user.

3. The optronic vision apparatus as claimed in claim 1, wherein the data processor is configured or programmed to synthesize in real-time a stream of said composite images from a stream of said first images and a stream of said second images.

4. The optronic vision apparatus as claimed in claim 1, wherein the image-displaying device is a portable displaying device equipped with orientation sensors, the apparatus also comprising a system for servo-controlling the orientation of the camera to that of the portable displaying device.

5. The optronic vision apparatus as claimed in claim 1, wherein the panoramic image sensor and the orientable camera are designed to operate in different spectral ranges.

6. The optronic vision apparatus as claimed in claim 1, wherein the panoramic image sensor is a hemispherical sensor.

7. The optronic vision apparatus as claimed in claim 1, wherein the orientable camera has a possibly variable field of view comprised between 1° and 20° and preferably between 3° and 12°.

8. An armored vehicle equipped with an optronic vision apparatus as claimed in claim 1.

9. A method implemented by an optronic apparatus as claimed in claim 1, comprising the following steps:
receiving a first image from a panoramic image sensor;
receiving a second image from an orientable camera, said second image having a better resolution in a field of view that is smaller than the field of view of the first image and that is contained in the latter field of view;
from the first and second images, synthesizing a composite image in which at least one section of the second image is embedded in a section of the first image, said composite image corresponding to an image that would be acquired by a virtual camera having the same orientation as said orientable camera, but a larger field of view; and
displaying said composite image.

10. The method as claimed in claim 9, wherein said composite image corresponds to an image that would be acquired by a virtual camera having the same orientation as said orientable camera, but a larger field of view.

11. The method as claimed in claim 9, also comprising the following step:
modifying the size of the field of view of said composite image in response to a command originating from a user.

12. The method as claimed in claim 9, wherein a stream of said composite images is synthesized in real-time from a stream of said first images and a stream of said second images.

13. The method as claimed in claim 9, wherein said composite image is displayed on a portable displaying device equipped with orientation sensors, the method also comprising the following steps:
determining the orientation of said portable displaying device from signals generated by said sensors; and
servo-controlling the orientation of the camera to that of the portable displaying device.
